(19) United States
(12) Patent Application Publication
(10) Pub. No.: US 2008/0176576 A1
(43) Pub. Date: Jul. 24, 2008

(54) Fast Indication of Uplink Voice Activity

(76) Inventors: John Walter Diachina, Garner, NC (US); Paul Schliwa-Bertling, Ljungsbro (SE); Bogdan Sutkowski, Apex, NC (US)

Correspondence Address: COATS & BENNETT, PLLC, 1400 Crescent Green, Suite 300, Cary, NC, 27518, US

(21) Appl. No.: 12/017,435

(22) Filed: Jan. 22, 2008

Related U.S. Application Data
(60) Provisional application No. 60/886,141, filed on Jan. 23, 2007.
(60) Provisional application No. 60/888,152, filed on Feb. 5, 2007.
(60) Provisional application No. 60/916,649, filed on May 8, 2007.

(51) Int. Cl. H04Q 7/20

(52) U.S. Cl. 455/450

(57) ABSTRACT

A mobile station operating in extended uplink TBF mode detects renewed data activity. Upon receiving an allocation of an uplink transmission opportunity, the mobile station determines whether a data block corresponding to the renewed data activity is ready for transmission. If the data block is not ready for transmission, a dummy block, comprising an indication that one or more uplink data packets are pending, is sent to the base station at the allocated transmission opportunity. The base station responds by resuming continuous mode scheduling of the uplink for the mobile station.

### RELATED APPLICATIONS

The present application claims priority under 35 U.S.C. § 119(e) to provisional application Ser. No. 60/886,141, filed Jan. 23, 2007, Ser. No. 60/916,649, filed May 8, 2007, and Ser. No. 60/888,152, filed Feb. 5, 2007, the contents of which are each incorporated herein.

### TECHNICAL FIELD

The present invention relates generally to packet data communications over wireless networks, and more particularly to methods and apparatus for signaling for uplink packet transmission resources at a mobile station in discontinuous transmission mode.

### BACKGROUND

The General Packet Radio Service (GPRS) standard and its successor Enhanced General Packet Radio Service (EGPRS) were developed to provide packet data services to mobile stations. The GPRS/EGPRS standards enable multiple mobile stations to share the same time slot or time slots for uplink communications. When establishing a packet data session, the mobile station is assigned one or more time slots in the uplink and downlink. In the channel assignment, the mobile station is given a Temporary Flow Identifier (TFI) and Uplink State Flag (USF).

For downlink communications, data blocks transmitted on the downlink include a TFI in the header to identify the mobile station for which the data block is intended. Each mobile station monitors its assigned time slots on the downlink and decodes the data blocks that include its TFI.

For uplink communications, a scheduler at the base station schedules the mobile stations sharing the same time slot or time slots. The scheduler indicates when a particular mobile station is scheduled to transmit in a given uplink time slot by including that mobile station's USF in a data block transmitted in a corresponding downlink time slot. A mobile station is allowed to transmit on the uplink when it detects its USF in the data block transmitted in the corresponding downlink time slot.

In order to reduce interference and save battery power, the mobile station may operate in a Discontinuous Transmission mode (DTX). In DTX mode, the mobile station may turn its transmitter off during periods when it does not have any data to send. For example, in a voice-over-Internet-Protocol (VoIP) session, a mobile phone user may be listening to a remote user. While the mobile phone user is not speaking, there is no data to send. Thus, interference may be reduced and power saved in DTX mode. When the mobile phone user begins speaking, the mobile station may switch back to a continuous transmission mode.

Typically, when the mobile station is in discontinuous transmission mode, the scheduler at the base station is notified or may otherwise determine when the mobile station has transitioned into DTX mode. This is necessary (or at least beneficial) to avoid wasting uplink bandwidth, since the mobile station will not have any data to send to the base station. Once it determines that a particular mobile is in DTX mode, the scheduler may allocate uplink time slots less frequently. For instance, rather than scheduling one or more time slots for the mobile station in each uplink radio block, the scheduler may instead allocate a time slot in every second radio block, or in every fourth radio block.

Similarly, when the mobile station transitions from DTX mode back to continuous transmission mode, the scheduler needs to be notified or otherwise determine when this transition has occurred so that it may resume normal USF scheduling. Upon learning that a mobile station has entered continuous transmission mode, the scheduler may thus allocate time slots to the mobile station more frequently, such as one or more time slots to the mobile in every radio block.

Some applications, such as VOIP, are highly sensitive to latency. Therefore, when a mobile station transitions from DTX mode to continuous transmission mode, normal USF-based scheduling needs to resume as quickly as possible in order to avoid latency in the delivery of data to the far-end user. This is especially true for real-time voice applications, where excessive latency may cause noticeable interruptions in speech and therefore degrade the perceived quality of the connection.

### SUMMARY

The present invention provides a method for signaling to a base station that a mobile station in DTX mode has transitioned to a continuous transmission mode so that normal uplink scheduling may resume. In an exemplary embodiment, a mobile station operating in extended uplink TBF mode detects renewed data activity for the uplink, such as speech activity detected by a voice activity detector. Upon receiving an allocation of one or more uplink transmission periods, the mobile station determines whether a data block corresponding to the renewed data activity is ready for transmission. If the data block is not ready for transmission, a dummy block, comprising an indication that one or more uplink data packets are pending, is sent to the base station. The base station responds by resuming continuous mode scheduling of the uplink for the mobile station.

### BRIEF DESCRIPTION OF THE DRAWINGS

FIG. 1 shows a block diagram of the main functional elements of a GSM/EDGE network.

FIG. 2 shows an exemplary protocol architecture for packet data transmission in GPRS networks.

FIG. 3 shows transmission of packet data in a GPRS network.

FIG. 4 shows USF-based scheduling in a GPRS network.

FIG. 5 illustrates the potential impact of processing delays at a mobile station on USF-based scheduling.

FIG. 6 illustrates an exemplary dummy data block according to one or more embodiments of the present invention.

FIG. 7 illustrates an exemplary USF-based scheduling scenario according to one or more embodiments of the present invention.

FIG. 8 is a logic flow diagram illustrating an exemplary method for signaling a request for uplink packet data transmission resources at a mobile station in DTX transmission mode.

FIG. 9 is a block diagram illustrating an exemplary mobile station.

### DETAILED DESCRIPTION

The present invention will be described in the context of a third generation (3G) mobile communication network, such as a GSM/EDGE network. Those skilled in the art will appreciate, however, that the present invention is applicable to systems implementing other standards. Therefore, the description should not be construed as limiting the present invention to GSM/EDGE networks.

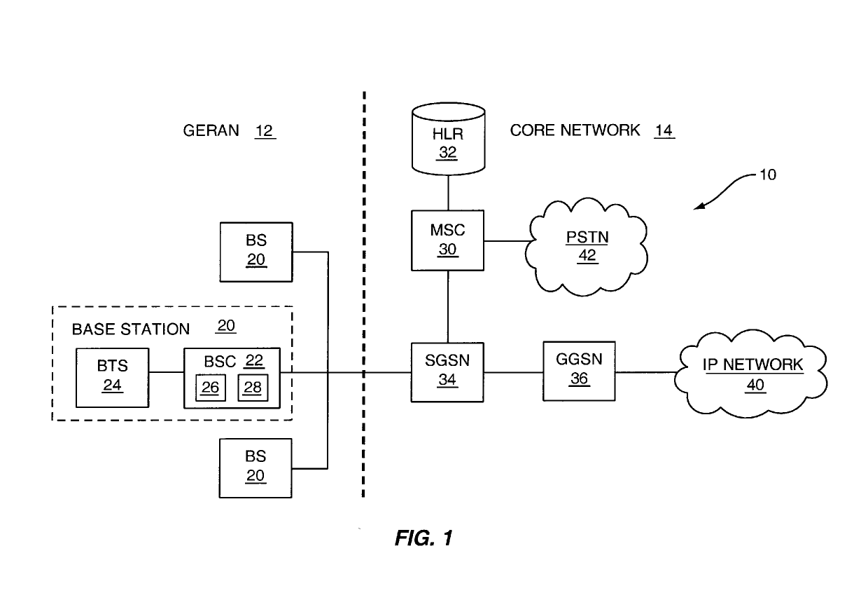

FIG. 1 illustrates an exemplary GSM/EDGE network indicated generally by numeral 10. The GSM/EDGE network 10 comprises a GSM/EDGE Radio Access Network (GERAN) 12 and a core network 14. The GERAN 12 typically comprises one or more Base Station Subsystems (BSSs) 20, hereinafter referred to simply as base stations 20. Each base station 20 comprises a Base Station Controller (BSC) 22 and one or more Base Transceiver Stations (BTSs) 24. BTS 24 comprises the antennas, RF equipment, and baseband processing circuits needed to communicate with mobile stations. The BSC 22 connects the base station 20 to the core network 14 and controls the radio resources of the GERAN 12. BSC 22 may include a scheduler 26 for scheduling uplink transmissions by mobile stations over shared packet data channels. The BSC 22 may further include a detection unit 28 for detecting the transition of the mobile station from DTX mode to continuous transmission mode. The functions of the scheduler 26 and detection unit 28 may be implemented using one or more processors, microcontrollers, hardware, or a combination thereof.

Core network 14 comprises at least one Mobile Switching Center (MSC) 30, a Home Location Register (HLR) 32, at least one Serving GPRS Support Node (SGSN) 34, and one or more Gateway GPRS Support Nodes (GGSN) 36. The core network 14 provides connectivity to various external networks for both circuit-switched and packet data communication. The MSC 30 handles circuit-switched communications and connects to the Public Switched Telephone Network (PSTN) 42 as known in the art. The HLR 32 stores subscriber information and the current location of the subscriber. The SGSN 34 handles packet data communications with mobile stations. The GGSN 36 provides connection to external packet-switched networks, 40, such as the Internet.

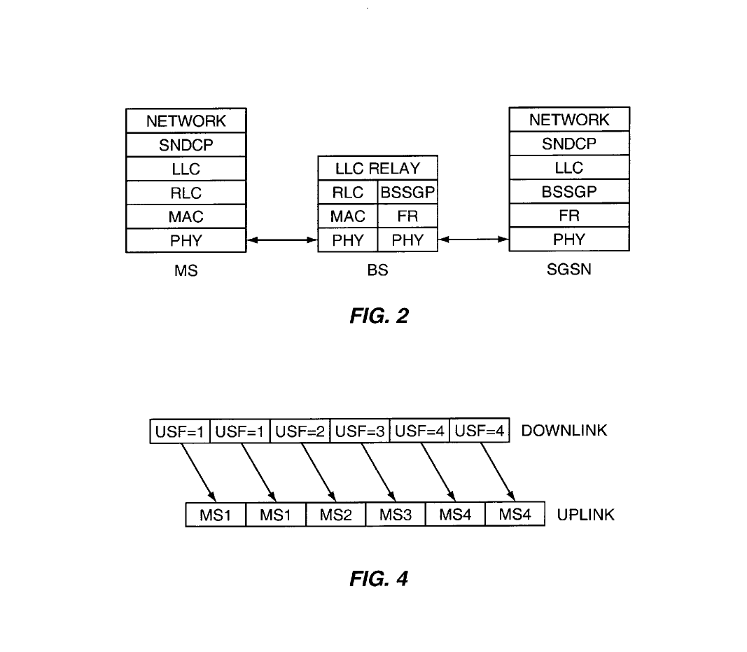

FIG. 2 illustrates packet data protocols used in GPRS networks and GPRS-equipped mobile stations to enable transfer of packet data between the mobile station and the SGSN 34. The GPRS protocol stack includes the Network layer, the SubNetwork Dependent Convergence Protocol (SNDCP) layer, the Logical Link Control (LLC) layer, the Radio link control (RLC) layer, the Medium access Control (MAC) layer, the BSS GPRS Protocol (BSSGP) layer, the Network Services (NS) layer, and the Physical Layer (PL). The SNDCP layer receives data packets, such as IP packets from the network layer. The SNDCP layer is responsible for compressing the IP packets and multiplexing IP packets from different sources. The LLC layer is responsible for the transfer of packet data between the mobile station and a SGSN 34. The LLC layer converts SNDCP PDUs received from the SNDCP layer into LLC protocol data units (PDUs), which are passed down to the RLC layer. The RLC layer is responsible for the transfer of data between the mobile station and base station 20. The RLC layer segments each LLC PDU into one or more RLC data blocks at the transmitter, and reassembles the RLC data blocks into LLC PDUs at the receiver. The RLC layer also implements a retransmission protocol to enable the receiver to request retransmission of missed RLC data blocks. In some embodiments of the present invention, detection unit 28 is also part of the RLC layer. The MAC layer handles multiplexing of mobile stations and enables multiple mobile stations to share the same packet data channel. In some embodiments, the scheduler 26 is part of the MAC layer. The BSSGP layer conveys routing and Quality Of Service (QOS) related information between the base station 20 and SGSN 34. The BSSGP layer provides transport of LLC PDUs between SGSN 34 and base station 20. The NS layer provides transport for BSSGP Signaling Data Units (SDUs) between SGSN 34 and base station 20.

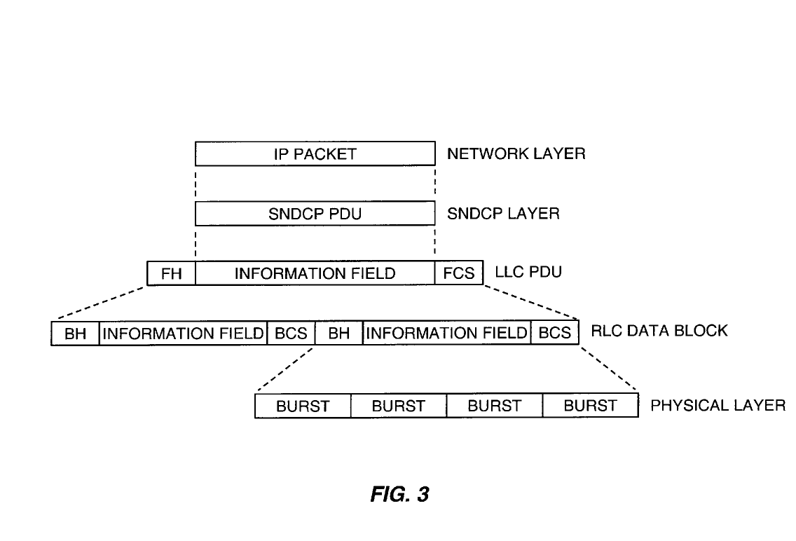

FIG. 3 illustrates how data packets, such as IP packets, are transmitted over a GPRS network. Each IP packet received from the network layer is mapped into one SNDCP PDU, and each SNDCP PDU is mapped into one or more LLC PDUs. Each LLC PDU, also called LLC frames, includes a Frame Header (FH), an information field, and a Frame Check Sequence (FCS). Each LLC PDU is, in turn, typically mapped onto one or more RLC data blocks. The RLC data blocks include a block header (BH), information field, and Block Check Sequence (BCS), which may be used by the receiver to check for errors in the RLC data block. The RLC data blocks are then mapped onto physical layer radio blocks which are further comprised of bursts. In a typical GPRS system, one RLC data block is mapped onto four physical layer bursts, which may be transmitted in the four instances of a given timeslot in a GPRS radio block.

The BH for a downlink RLC data block includes an Uplink State Flag (USF) to support dynamic scheduling of mobile stations on the uplink. Each mobile station that shares an uplink timeslot (packet data channel) is assigned a unique USF corresponding to that timeslot. The USF typically contains three bits, allowing the uplink packet data channel to be shared by up to eight different users. A USF is included in the header of each RLC data block transmitted on the downlink to indicate to the corresponding mobile station that it is scheduled for the next instance of that uplink timeslot. The mobile stations sharing the same uplink timeslot monitor the transmissions on the corresponding downlink timeslot. When a mobile station detects its own USF in the downlink transmission, the mobile station is free to transmit in the next corresponding uplink timeslot as shown in FIG. 4.

FIG. 4 illustrates six consecutive timeslots for a GPRS physical channel. Those skilled in the art will appreciate that only the timeslots for a single GPRS physical channel are shown; intervening time slots, which may be occupied by other GPRS channels or GSM channels, are not shown. A first mobile station (MS1) is scheduled to transmit in the first two uplink timeslots, a second mobile station (MS2) is scheduled to transmit in the third uplink timeslot, a third mobile station (MS3) is scheduled to transmit in a fourth uplink timeslot, and a fourth mobile station (MS4) is scheduled to transmit in the fifth and sixth uplink timeslots. Scheduler 26 at the BSC 22 determines which mobile stations are allowed to transmit in which timeslots.

In order to save battery power and reduce interference, a mobile station may operate in a Discontinuous Transmission (DTX) mode. In DTX mode, the mobile station turns its transmitter off during periods when it does not have any data to send. For example, in voice-over-Internet-Protocol (VoIP), the mobile phone user may be listening to a remote user. While the mobile phone user is not speaking, there is no data to send, so interference may be reduced and power saved by turning off the transmitter. When the mobile phone user resumes speaking, the mobile station may switch back to a continuous transmission mode.

When the mobile station is in DTX mode, the scheduler 26 at the base station 20 is notified so that the scheduler 26 will reduce USF scheduling while the mobile station is in DTX mode. Full scheduling for a mobile station in DTX mode would waste uplink resources because the mobile station does not have user data to send. When the mobile station has user data to send, it will transition back from DTX mode to continuous transmission mode. Some applications, such as VoIP, are highly sensitive to latency. Therefore, when a mobile station transitions from DTX mode to continuous transmission mode, normal USF-based scheduling needs to resume as quickly as possible in order to avoid excessive packet latency.

When a mobile station in DTX mode is scheduled for an uplink transmission, it may use the scheduled uplink transmission to transmit either control messages or user data (e.g., speech). When the RLC data blocks are received at the base station 20, the base station 20 determines whether the RLC data blocks contain control messages or user data. If the RLC data block contains control messages, the base station 20 may assume that the mobile station is still in DTX mode. On the other hand, if the RLC data block contains user data (e.g., speech), then the base station 20 may assume that the mobile station has transitioned to continuous transmission mode, and resume normal USF-based scheduling. Thus, receipt of an RLC data block containing speech may be used to implicitly signal the transition from DTX mode to continuous transmission mode.

While a mobile station is in DTX mode during a VoIP session, a voice activity detector (VAD) typically monitors an audio input to detect the presence of renewed speech activity. When speech is detected, the audio is digitized, encoded (e.g., using AMR, or Adaptive Multi-Rate coding), and assembled into frames (e.g., according to the Real-time Transport Protocol, or RTP). These speech frames are then supplied to the mobile station's network layer (as shown in FIG. 2) for processing and transmission to the base station 20.

However, encoding the detected speech and processing the speech frames at each layer of the protocol stack takes a certain amount of time. To begin with, the speech data is typically encoded into AMR format using 20-millisecond speech samples. Two AMR frames may be assembled into a single RTP frame carrying 40 milliseconds of speech data. Thus, a fully-loaded RTP frame may not be available for processing until up to 40 milliseconds after new speech activity is first detected. Processing the encoded speech data at the LLC and RLC layers consumes additional time.

These delays mean that a mobile station operating in DTX mode may become “aware” of new speech activity but be unable to actually transmit that new speech data in time for the next scheduled uplink transmission opportunity. If the base station 20 depends upon the receipt of new speech data to determine that the mobile station is transitioning to continuous mode, then allocation of additional resources will in this case become delayed, adding latency to the VoIP session.

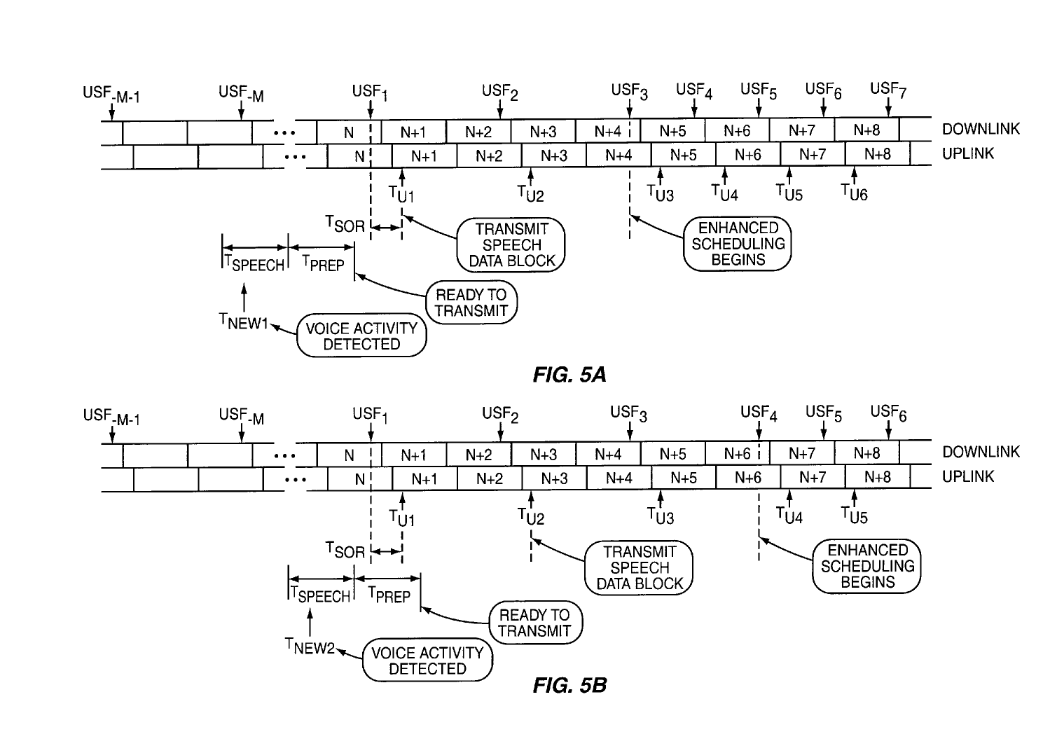

FIG. 5 illustrates the impact of these delays on USF-based scheduling. In FIGS. 5A and 5B, the base station 20 initially considers the mobile station to be in extended uplink Temporary Block Flow (TBF) mode, with the mobile station's TBF assigned to timeslot 3 of each radio block period N, N+1, etc. Uplink State Flags USF₁, USF₂, and USF₃ are addressed to the same mobile station and, because the mobile station is in DTX mode, are transmitted only every second radio block, i.e., radio blocks N, N+2, and N+4. The allocated uplink timeslots corresponding to USF₁, USF₂, etc., follow the Uplink State Flags by the standard offset reference time T_{SOR}, e.g., 10 timeslots (5.77 milliseconds). Thus, uplink transmit opportunities for that mobile station are shown in FIGS. 5A and 5B at T_{U1}, T_{U2}, and T_{U3}, i.e., at radio blocks N+1, N+3, and N+5. In FIG. 5A, new speech activity is detected by the voice-activity detector at time T_{NEW1} which may occur anywhere during a given speech coding interval (e.g. not necessarily at the beginning of a 20 ms speech coding interval). A speech coding interval and assembly of a corresponding RTP frame requires a time duration of T_{SPEECH}. In FIG. 5A T_{NEW1} is shown as occurring about one-third of the way through a speech coding interval, but may in practice occur at any time during any given speech coding interval. Even assuming that only one 20-millisecond speech coding interval is included in the first RTP frame, T_{SPEECH} is somewhat greater than 20 milliseconds (e.g., perhaps 25 milliseconds, due to 5 ms of processing time required to complete the RTP frame carrying the speech payload of the speech coding interval). If two 20-millisecond speech coding intervals are included in an RTP frame, than T_{SPEECH} is similarly somewhat greater than 40 milliseconds, with the exact value depending on the processing resources available in the mobile station. In either case, once the RTP frame is completed, the mobile station requires additional time, T_{PREP}, to prepare the completed speech frame for transmission in an uplink radio block, e.g., to migrate the RTP frame into the UDP/IP/SNDCP/LLC protocol stack, map the LLC frame into one or more RLC data blocks, segment, code, and puncture the first of potentially multiple RLC data bocks required to transmit the LLC frame. This might take, for example, 32 timeslots (approximately 18.64 milliseconds).

If speech activity is detected at T_{NEW1}, as illustrated in FIG. 5A, then a speech data block is ready for transmission at the uplink slot designated by T_{U1}, at radio block N+1. Once the speech data block is received and processed at the base station 20, the base station scheduler 26 can begin allocating additional uplink resources, e.g., by sending a USF for the mobile station in every radio block, perhaps beginning with USF₃ at radio block N+4. Note that because of signal propagation delays and processing delays, base station 20 may not necessarily be ready to transmit an additional USF for the mobile station at radio block N+3. Thus, the mobile station is able to begin transmitting speech data at every radio block beginning with radio block N+5 (assuming that the normal rate of USF scheduling is every radio block once the base station scheduler 26 determines that speech activity has resumed).

In contrast, if speech activity is detected at T_{NEW2}, as illustrated in FIG. 5B, then the speech data block is not ready until after T_{U1}. Thus, a first data speech block is not transmitted until T_{U2}, at block N+3. Assuming the same turnaround time, base station 20 is thus unable to increase the USF scheduling for the mobile station until USF₄, beginning with block N+6. The mobile station is only able to begin transmitting speech data at every radio block beginning with radio block N+7. From examining FIGS. 5A and 5B, those skilled in the art will appreciate that very small differences in the time at which new speech is first detected, i.e., small differences between T_{NEW1} and T_{NEW2}, can result in an added delay of two radio blocks before continuous USF scheduling is resumed. This added delay can be longer in scenarios where uplink timeslots are allocated to a mobile station in DTX mode even less frequently.

The methods and apparatus disclosed herein are thus directed to reducing the probability that the mobile station will experience a delay, like the one illustrated in FIG. 5, in informing the base station 20 of resumed uplink speech activity. This can be done by sending to base station 20 an indication that uplink speech has resumed at the first available uplink transmit opportunity, even if a speech data block is not yet available to send at that first opportunity.

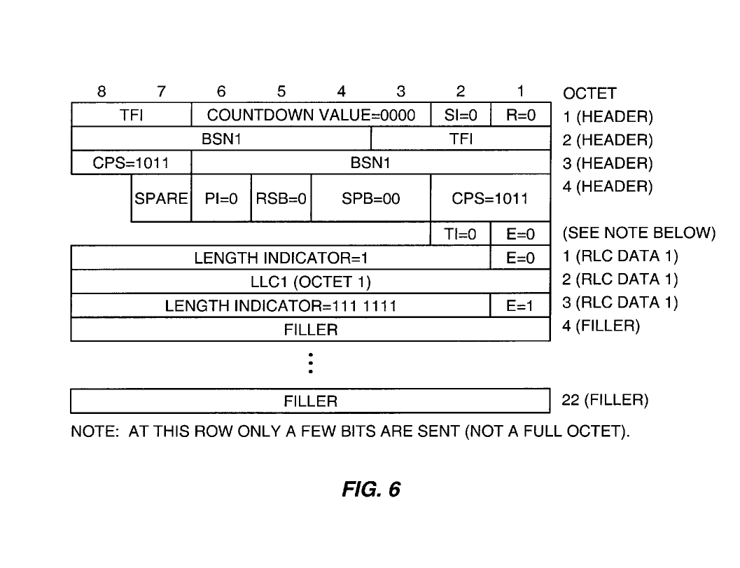

In one embodiment of the present invention, a mobile station operating in extended uplink TBF keeps a “dummy” uplink EGPRS RLC data block on “hot standby,” i.e., coded, punctured, and ready for transmission. One possible format for an EGPRS RLC data block is illustrated in FIG. 6. The dummy data block is created according to MCS-1, and contains data indicating that speech activity has resumed and that speech data blocks are pending. In an exemplary embodiment, the dummy data block may be coded to indicate that that it carries a LLC PDU having a length of 1 octet; this may be interpreted by base station 20 as indicating that speech activity has resumed and that USF-based allocation of timeslots should be increased for the mobile station. Thus, whenever the mobile station detects new uplink speech activity for an uplink TBF operating in extended uplink TBF mode but is unable to begin the transmission of an uplink EGPRS data block containing some portion of the new speech payload in time for the next USF-based transmission opportunity, it will instead transmit the hot standby EGPRS RLC data block. If, on the other hand, the mobile station detects new uplink speech activity and a data block containing the new speech data is ready at the next scheduled uplink transmission opportunity, then the mobile station simply starts transmitting the new speech data at that scheduled opportunity.

When base station 20 receives an uplink RLC data block from a mobile station it considers to be in extended uplink mode (i.e., DTX mode), the response will depend on whether the RLC data block contains speech or is a dummy data block. Thus, in some embodiments a received data block encoded using MCS-1 and indicating that it carries an LLC PDU of length 1 is interpreted as a “hot standby” data block. Base station 20 will in this case resume normal USF scheduling for the corresponding TBF.

In some embodiments, an RLC data block encoded using MCS-1 and indicating the presence of a single LLC PDU of length 2-21 might be interpreted as carrying only a Silence Insertion Description (SID), i.e., a comfort noise frame. (An LLC PDU carrying a SID frame should generally never exceed 21 octets in length.) In this case, base station 20 should generally not resume normal uplink scheduling for the corresponding TBF, as there is no indication that speech activity has been detected.

In some embodiments, an uplink EGPRS RLC data block indicating the presence of an LLC PDU of length greater than 21 octets may be interpreted by the base station 20 as carrying a speech frame. In this case, normal USF scheduling should be resumed for the corresponding TBF. (The smallest AMR frame is 95 bits long, and will typically be bundled so that each RTP frame carries two AMR frames. When overhead for UDP, IP, SNDCP, and LLC are added, the corresponding LLC PDU will generally exceed 21 octets in length.)

Those skilled in the art will appreciate that the techniques described above allow the mobile station to signal the base station 20 that speech activity is pending, even if speech data is not ready to be transmitted at the first uplink transmission opportunity after the speech activity is first detected by the mobile station. This signaling allows the base station 20 to increase the uplink resources available for the mobile station's uplink TBF used to carry speech data.

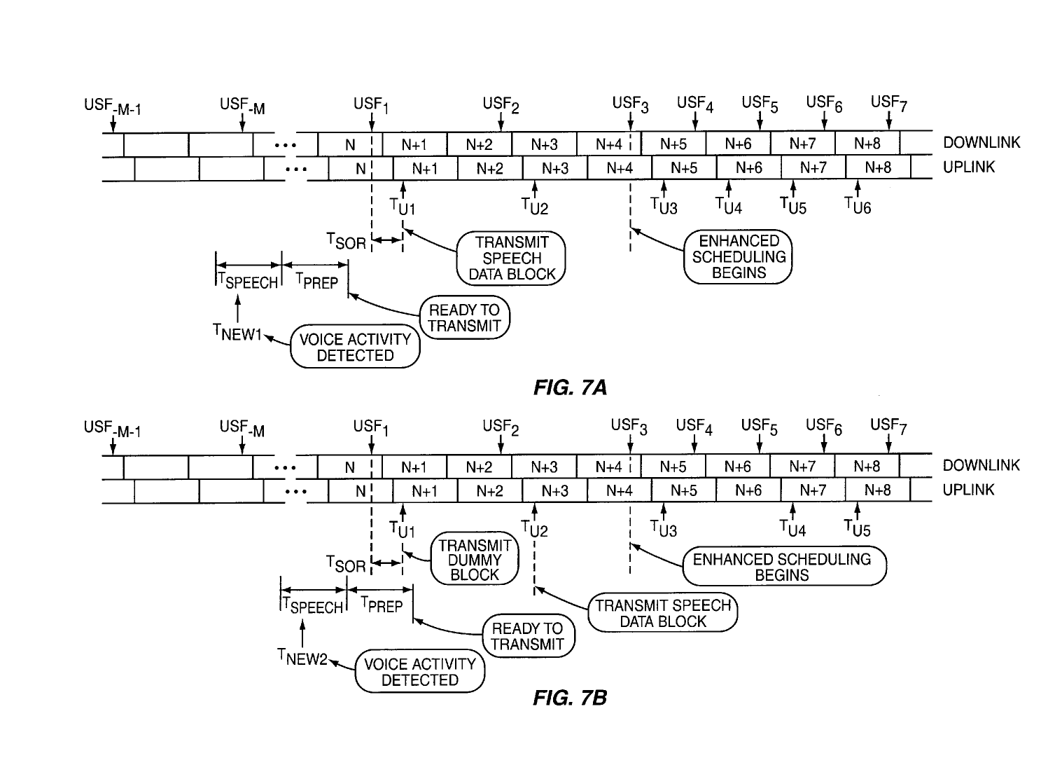

This is illustrated in FIG. 7, which illustrates the same scenario as FIG. 5, except that the signaling techniques described above are employed. FIG. 7A is identical to FIG. 5A. Because a speech data block is ready to transmit before T_{U1}, the speech data block is transmitted in the corresponding uplink timeslot. Upon receiving the speech data block, base station 20 recognizes that speech has resumed, and begins sending USFs on every block, starting with downlink block N+4.

In FIG. 7B, a speech data block resulting from newly detected voice activity is not ready for transmitting until after T_{U1}. As was demonstrated in FIG. 5B, if nothing is sent until the next available timeslot, then full USF scheduling will not begin until downlink block N+6. However, because voice activity is detected well before T_{U1}, then a “hot” dummy block can be sent at T_{U1}, indicating to the base station 20 that speech data is being processed at the mobile station and that continuous mode should thus be initiated. Accordingly, USF scheduling at every block resumes at downlink block N+4, just as in FIG. 7A.

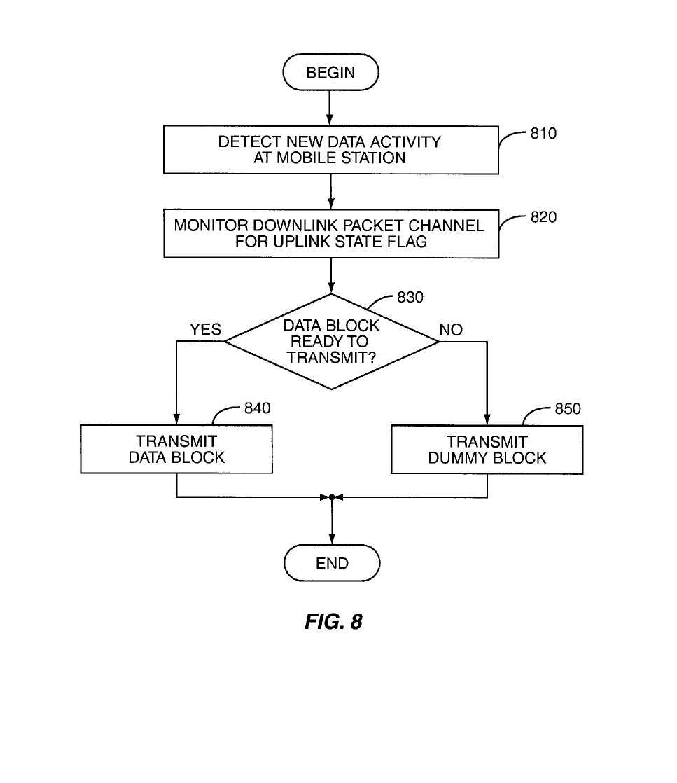

FIG. 8 illustrates an exemplary method implemented at a mobile station for signaling a request for uplink packet transmission resources, i.e., for indicating to the serving base station 20 that the mobile station is transitioning from DTX mode to continuous mode. The procedure generally applies when the mobile station is in DTX mode, although the method may be used even if the mobile station does not “know” that the base station 20 considers the mobile station to be in DTX mode. The manner in which this determination is made by the base station is not material.

At block 810, the mobile station detects new data activity. In some embodiments, such as when the method of FIG. 8 is used to improve VoIP performance, new data activity may be detected by a voice activity detector (VAD); an output signal from the VAD indicating that speech has been detected may be supplied to the MAC layer of the GPRS protocol stack. In other embodiments, the receipt of a data unit for processing by a protocol layer may constitute a triggering event indicating new data activity. For instance, new data activity might be detected by determining that a new uplink RTP frame is available, or by determining that the RLC layer has received an LLC PDU for processing. Those skilled in the art will thus appreciate that the present invention is by no means limited to speech applications, but is generally applicable to data services utilizing a discontinuous transmission mode.

At block 820, the mobile station monitors a downlink packet channel for a signal allocating to the mobile station a transmission opportunity in a corresponding uplink packet channel. In embodiments where GPRS/EGPRS is used, the mobile station monitors a downlink packet channel for a Uplink State Flag associated with the mobile station, the Uplink State Flag indicating that a corresponding timeslot in the next uplink radio block is allocated to the mobile station.

At block 830, the mobile station determines whether a completed RLC data block (potentially the first of many) carrying the new speech data is ready to transmit in time to be transmitted at the next allocated uplink timeslot. If an RLC data block is ready, then it is transmitted, at block 840. If not, a dummy block indicating that new speech data is pending is transmitted at the allocated uplink transmission opportunity, as shown at block 850.

Those skilled in the art will appreciate that the determination at block 830 of whether a completed RLC data block carrying new data corresponding to the detected new data activity is ready for transmitting at the next allocated transmission opportunity must be performed early enough to properly prepare the mobile station to transmit the RLC data block at the next allocated transmission opportunity. Thus, this determination must be made at a pre-determined reference time occurring somewhat before the allocated transmission opportunity begins, the exact interval depending on the implementation details of the mobile station. The time at which this decision must be made is effectively also the last point in time at which new data activity can be detected, such that the detection still results in the transmission of a dummy block. Those skilled in the art will appreciate that shortening this interval reduces the probability that an opportunity is missed for notifying the base station 20 that data activity has resumed.

One way to reduce this interval is to pre-process the dummy block as much as possible, so that little processing is required after the decision is made to transmit the dummy block. Thus, in some embodiments, the pre-determined dummy block is encoded and punctured ahead of time, to be ready for transmission at very short notice.

FIG. 7 illustrates a hot standby EGPRS RLC data block that may be used in one or more embodiments of the invention. As explained above, the receiving base station 20 may be configured to recognize that an LLC PDU length indicator indicating that the RLC payload is a single LLC octet actually indicates that the received packet is a dummy packet, which should be interpreted as indicating that new data activity is pending at the mobile station, and that uplink scheduling for the mobile station's TBF should be increased. Those skilled in the art will appreciate, however, that dummy blocks of several different formats are possible. For instance, in another embodiment of the present invention, the dummy block comprises an Uplink Dummy Control Block carrying data that indicates that the Uplink Dummy Control Block should be interpreted by the base station 20 as indicating that new data activity is pending. In some embodiments, the block check sequence (BCS) bits of the Uplink Dummy Control Block may be inverted to indicate that new data activity is pending. Uplink Dummy Control Blocks containing normal, i.e., non-inverted, BCS bits would be processed by base station 20 as usual.

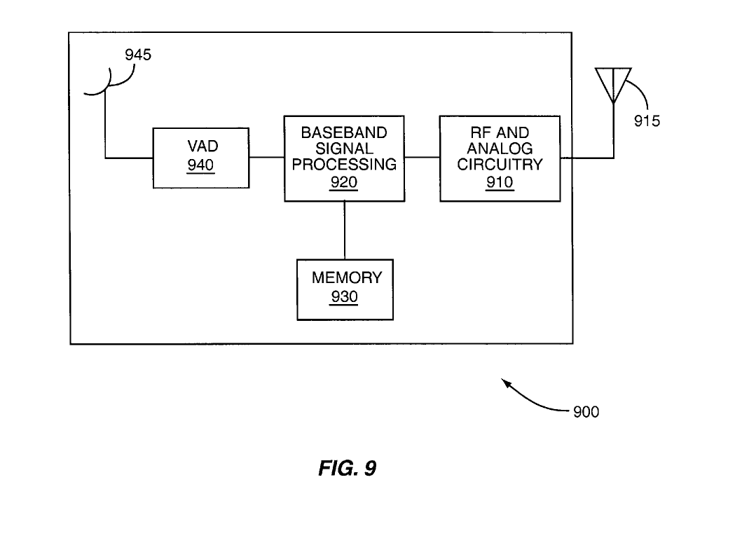

FIG. 9 provides a functional block diagram for an exemplary mobile terminal 900, configured to perform one or more of the methods described herein. Mobile terminal 900 comprises analog and radio frequency (RF) circuitry 910 connected to antenna 915, baseband signal processing unit 920, and memory 930. Analog and RF circuitry 910 comprises conventional radio-frequency components for receiving and sending transmissions between mobile station 900 and base station 20. Baseband signal processing unit 920, which may comprise one or more general-purpose or customized microprocessors, microcontrollers, and or digital signal processors (DSPs), is configured, in some embodiments using program code stored in memory 930, to detect new activity at mobile station 900, the new data activity indicating that one or more uplink data packets are pending. Baseband signal processing unit 920 is further configured to monitor a downlink packet channel (e.g., an EGPRS downlink channel) for a signal allocating a transmission period in a corresponding uplink packet channel to the mobile station 900. After receiving the allocation, baseband signal processing unit 920 transmits a pre-determined dummy block over the uplink packet channel during the allocated transmission period if a data block corresponding to the new data activity is not ready for transmission. In some embodiments, baseband signal processing unit 920 is configured to detect speech activity at microphone 945, using voice activity detector 940. In these embodiments, if a speech data block is not ready for transmission at the next scheduled uplink transmission opportunity, the pre-determined dummy block is transmitted instead, the dummy block indicating to the base station 20 that speech activity is pending and that uplink speech data blocks should be expected.

As discussed above, base station 20 receives the dummy block and interprets it to indicate that uplink data blocks are pending and that more frequent uplink transmission opportunities for the mobile station 900 should be granted. Thus, an exemplary embodiment of base station 20 comprises a base station transceiver 24, configured to transmit packet data to and receive packet data from a mobile station 900, a scheduler 26 for scheduling an uplink transmission by the mobile station 900 during an uplink transmission period while the mobile station is in DTX mode, and a detection unit 28 for determining whether a data block received from the mobile station 900 during the scheduled uplink transmission period comprises a pre-determined dummy block indicating that uplink packet data from the mobile station 900 is pending. Upon detection of such a dummy block by the detection unit 28, the scheduler 26 is configured to begin allocating uplink transmission periods to the mobile station 900 in a continuous transmission mode. Depending on various factors, such as system loading, quality-of-service guarantees, and the like, the scheduler 26 may allocate one or more uplink timeslots for the mobile station 900 in each radio block of the uplink.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method for signaling a request for uplink packet transmission resources at a mobile station in DTX transmission mode, comprising:
detecting new data activity at the mobile station, the new data activity indicating that one or more uplink data packets are pending;
monitoring a downlink packet channel for a signal allocating to the mobile station one or more transmission periods in a corresponding uplink packet channel; and
transmitting a pre-determined dummy block over the uplink packet channel during the allocated one or more transmission periods, the pre-determined dummy block comprising an indication that the one or more uplink data packets are pending.

2. The method of claim 1, wherein detecting new data activity comprises detecting speech activity using a voice activity detector.

3. The method of claim 1, wherein detecting new data activity comprises receiving a packet data unit for processing according to a radio link control (RLC) protocol.

4. The method of claim 1, wherein the uplink and downlink packet channels comprise General Packet Radio Service (GPRS) channels, and wherein the signal comprises an Uplink Status Flag (USF) corresponding to the mobile station.

5. The method of claim 4, wherein the pre-determined dummy block comprises an uplink dummy control block with inverted block check sequence (BCS) bits.

6. The method of claim 4, wherein the pre-determined dummy packet comprises a pre-coded radio link control (RLC) data block including RLC data uniquely indicating that one or more uplink data packets are pending.

7. The method of claim 6, wherein the RLC data comprises a length indicator indicating the presence of a logical link control (LLC) data unit having a length of one octet.

8. The method of claim 1, further comprising, prior to transmitting the pre-determined dummy block over the uplink packet channel during the allocated one or more transmission periods, determining that no data block corresponding to the new data activity is ready for transmission during the allocated one or more transmission periods.

9. The method of claim 8, wherein said determining is based upon a processing status at a pre-determined reference time for at least one data block corresponding to the new data activity.

10. A mobile station, comprising:
a transceiver section configured to transmit packet data to and receive packet data from a base station,
and a processing unit configured to:
detect new data activity at the mobile station, the new data activity indicating that one or more uplink data packets are pending;
monitor a downlink packet channel for a signal allocating to the mobile station one or more transmission periods in a corresponding uplink packet channel; and
transmit a pre-determined dummy packet over the uplink packet channel during the allocated one or more transmission periods, the dummy packet comprising an indication that the one or more uplink data packets are pending.

11. The mobile station of claim 10, further comprising a voice activity detector (VAD) configured to detect user speech activity and to provide a speech activity detection signal to the processing unit, wherein the processing unit is configured to detect new data activity by receiving the speech activity detection signal.

12. The mobile station of claim 10, wherein the processing unit is configured to detect new data activity by detecting the receipt of a packet data unit for processing according to a radio link control (RLC) protocol.

13. The mobile station of claim 10, wherein the uplink and downlink packet channels comprise General Packet Radio Service (GPRS) or Enhanced General Packet Radio Service (EGPRS) channels, and wherein the processing unit is configured to monitor the downlink packet channel for an Uplink Status Flag (USF) corresponding to the mobile station.

14. The mobile station of claim 13, wherein the pre-determined dummy block comprises an uplink dummy control block with inverted block check sequence (BCS) bits.

15. The mobile station of claim 13, wherein the pre-determined dummy packet comprises a pre-coded radio link control (RLC) data block including RLC data uniquely indicating that one or more uplink data packets are pending.

16. The mobile station of claim 15, wherein the RLC data comprises a length indicator indicating the presence of a logical link control (LLC) data unit having a length of one octet.

17. A base station comprising:
a base station transceiver configured to transmit packet data to and receive packet data from a mobile station;
a scheduler for scheduling an uplink transmission by the mobile station during one or more uplink transmission periods while the mobile station is in a discontinuous transmission (DTX) mode; and
a detection unit for determining whether a data block received from the mobile station during the scheduled one or more uplink transmission periods comprises a pre-determined dummy block indicating that uplink packet data from the mobile station is pending;
wherein the scheduler is configured to begin allocating uplink transmission periods to the mobile station in a continuous transmission mode upon detection of the pre-determined dummy block by the detection unit.

18. The base station of claim 17, wherein the scheduler is configured to continue allocating uplink transmission periods to the mobile station in DTX mode if the data block is not the pre-determined dummy block.

19. The base station of claim 17, wherein the detection unit is configured to determine whether the data block comprises the pre-determined dummy block by determining whether the data block comprises an uplink dummy control block having inverted block check sequence (BCS) bits.

20. The base station of claim 17, wherein the detection unit is configured to determine whether the data block comprises the pre-determined dummy block by determining whether the data block comprises RLC data including a length indicator indicating the presence of a logical link control (LLC) data unit having a length of one octet.
